(19) United States
(12) Patent Application Publication
(10) Pub. No.: US 2012/0054092 A1
(43) Pub. Date: Mar. 1, 2012

(54) METHOD AND COMPUTER NETWORK FOR CO-ORDINATING FINANCIAL SERVICE/PRODUCTS

(76) Inventors: Tom Reddin, Charlotte, NC (US); David Anderson, Charlotte, NC (US); Douglas Lebda, Charlotte, NC (US); Ken Eckert, (US); Kamelia Dianati, (US); Joel Clark, (US); Jason Dahlin, (US)

(21) Appl. No.: 13/292,343

(22) Filed: Nov. 9, 2011

Related U.S. Application Data
(63) Continuation of application No. 12/366,340, filed on Feb. 5, 2009.
Application No. 12/366,340 is a continuation of application No. 11/046,545, filed on Jan. 28, 2005, now abandoned.
Application No. 11/046,545 is a continuation-in-part of application No. 10/985,336, filed on Nov. 10, 2004, now abandoned.
(60) Provisional application No. 60/641,650, filed on Jan. 5, 2005.

(51) Int. Cl. G06Q 40/02

(52) U.S. Cl. 705/38

(57) ABSTRACT

The invention relates to a method and a computer for coordinating an electronic qualification form between a consumer and a plurality of financial service providers and wholesale investors. After receiving qualification form data, a special processing computer applies a filter to the data. The filter comprises selection criteria provided by financial service providers and wholesale investors which allows these organizations to filter out qualification forms that they do not want. After the data is filtered, the qualification form can be transmitted to those organizations who match the data in the qualification form based on the filtration. According to one exemplary aspect, a financial coordinator who runs a computer matching engine can be a single point of contact for a consumer with respect to several wholesale investors of the financial coordinator who may offer the consumer financial products or services.

### CROSS REFERENCE TO RELATED APPLICATIONS

This application claims priority to and is a continuation of U.S. Non-Provisional application Ser. No. 12/366,340, filed Feb. 5, 2009, entitled, “Method and Computer Network for Co-Ordinating Financial Services/Products,” which claims priority to U.S. Non-Provisional application Ser. No. 11/046,545, filed Jan. 28, 2005, entitled, “Method and Computer Network for Co-Ordinating Financial Services/Products,” which is a continuation-in-part of U.S. Non-Provisional application Ser. No. 10/985,336, filed Nov. 10, 2004, entitled, “Method and Computer Network for Co-Ordinating a Loan Over the Internet,” which claims priority to U.S. Provisional Application Ser. No. 60/641,650, filed Jan. 5, 2005, entitled, “Method and Computer Network for Co-Ordinating a Financial Services/Products Over the Internet,” the contents of each application is hereby incorporated by reference.

### BACKGROUND OF THE INVENTION

1. The Field of the Invention

The invention relates to a process for coordinating financial service providers and consumers with a financial services/products processing computer over the Internet. The invention also relates to a process of providing access to multiple service providers with a single point of contact.

2. Conventional Art

(A) Problems with Coordinating Information among Financial Service Providers and Consumers

In the past, there was no way to apply for financial services/products from a multitude of financial institutions without physically going to or calling each financial institution and filling out a qualification form. This process was tedious and time consuming. All qualification forms for financial services/products usually required substantially the same information: name, address, phone number, social security number, occupation, debt, amount of loan, requested credit limit, etc.

Accordingly, there is a need in the art for a simple mechanism whereby a user can apply for financial services or products (or both) from a multitude of financial institutions by filling out one qualification form.

(B) Problems with Gaining Access to Multiple Financial Service Providers

To obtain several offers or leads to offers from a variety of sources, many financial coordinators work with many types of financial service providers. A financial coordinator can include, but is not limited to, a financial institution, a bank, a mortgage broker, a mortgage lender, and a computerized loan originator (CLO). A financial service provider can offer services as well as products.

A financial service provider can include, but is not limited to, a lender, a securities broker, an insurance underwriter, and an insurance agency. A lender can include, but is not limited to, a wholesale investor, a warehouse lender, a correspondent lender, a retail financial institution, a retail bank, a retail lender, a vehicle (e.g. automobile) lender, and a credit card company. A wholesale investor may include a business organization that sells specific financial products to other organizations and that does not typically sell directly to consumers. An example of a wholesale investor is a company who provides one type of financial product such as real estate secured products (e.g. mortgage loans and home equity loans/lines).

Financial products or services (or both) may include, but are not limited to, a small business loan, any assets secured by real estate, a commercial mortgage, a first mortgage, a second mortgage, insurance, a car loan, a student loan, a personal loan, a credit card, a bank account, a stock brokerage account, a retirement account, an equity line of credit, any vehicle loan, stocks, and bonds.

While financial coordinators can work with many different types of lenders to obtain a financial service or product (or both) for a consumer, financial coordinators, such as mortgage brokers, typically determine what single lender out of a group of lenders (such as mortgage companies) will close a business transaction for a consumer while, at the same time, give (or yield) the financial coordinator the most profit. In some instances, the financial coordinator may uncover several offers or programs available to the consumer from a single lender. However, the financial coordinator will usually only disclose a single lender or a single offer to the consumer in order to close the consumer's transaction such as a mortgage.

Meanwhile, the financial coordinator may have uncovered several other lenders or multiple programs from a single lender with better products or services (or both) that the consumer would not be aware of unless the financial coordinator disclosed them to the consumer.

Accordingly, there is a need in the art for a financial coordinator who can find and disclose several lenders to a consumer. There is also a need in the art for a financial coordinator who can act as a single point of contact for the consumer when the consumer wants or needs more information from one or more of the lenders that are discovered by the financial coordinator.

### SUMMARY OF THE INVENTION

1) Coordinating Information among Financial Service Providers and Consumers

According to a first exemplary aspect of the invention, needless repetitive qualification forms for financial products or services (or both) can be eliminated. Qualification forms, as defined herein, can comprise any type of forms that can be used to facilitate business between a consumer and another party, such as a financial service provider. As noted above, a financial service provider can offer services as well as products.

According to one exemplary aspect, a universal qualification form can be provided that allows a consumer to submit a single qualification form that can be assessed by or matched with a plurality of financial service providers. The qualification form can be completed over the Internet or over the phone with a representative of the financial coordinator completing the form for the consumer. Alternatively, the qualification form can be completed during a personal interview by a representative of the financial coordinator when the consumer is being interviewed by the representative.

Further, the qualification form can be submitted by numerous other methods, such as, but not limited to, fax, and wireless devices such as PDAs and text messaging using cell phones. The invention is not limited to how data from the qualification form is entered into a computer matching engine. The invention can include any type of communication channel for entering data from a qualification form into a computer matching engine.

After processing data from the qualification form, the financial service providers can then make offers to the consumer or provide leads towards offers to the consumer.

One exemplary method can comprise the steps of completing an electronic qualification form; matching the electronic qualification form to a filter comprising a plurality of selection criteria; transmitting the data to a plurality of financial service providers; and responding to the consumer. The qualification form can include a series of questions pertaining to a desired financial product or service (or both). Financial products or services (or both) may include, but are not limited to, any real-estate secured asset, mortgages (residential or business, first or second); equity lines of credit; vehicle loans (airplanes, automobiles, boats, cars, motorcycles, and any other type of motorized vehicles); educational loans (elementary, high school, undergraduate, graduate); bank accounts, credit cards, retirement accounts, personal loans, stocks, and bonds.

Upon completion of some or all data for a qualification form, a computer matching engine can apply a unique filter to the data listed in the qualification form. In other words, a unique filter can be applied to a qualification form after some data is entered in the qualification form, or in the alternative, the unique filter can be applied to some of the data received from a qualification form. The data from a qualification form can be any type of data. Such data can include, but is not limited to, name, address, phone number, e-mail address, social security number, occupation, income, debt, amount of loan, requested credit limit, desired financial service or product, etc.

The filter can be made up of a plurality of selection criteria in which a financial service provider has provided to a database coupled to the computer matching engine. The computer matching engine can include a single computer running software or a plurality of computers running various modules. The computer matching engine can also include hard-wired devices or firmware or any combination of hardware, software, and firmware.

The filters of the computer matching engine may be customizable by financial service providers in real time and they may be unique to each financial service provider. Once a qualification form has been filtered by the computer matching engine, it can be sent to some or all of the financial service providers who match the qualification form.

Once data from a qualification form is sent, the financial service providers who receive a particular qualification form can respond by sending an offer or a lead to a financial offer back to the financial coordinator. A lead to a financial offer can include a name and a phone number to a representative of a financial service provider. The financial service providers may also choose not to respond (and not send any offers or leads to offers in response) to receiving a matching qualification form.

The qualification forms can be transmitted to financial service providers in many different ways. For example, the information can be sent in an Active File Transfer system (AFTS), via e-mail, through a secured webpage or through a Common Gateway Interface (CGI). In addition, since much of the information relayed between the network of computers is private information, it is encrypted before it is sent from one computer to another. For some wholesale investors, a financial coordinator may create and maintain the filters and databases for the wholesale investors as agents of the wholesale investors. In this case, the financial coordinator will not need to transmit a matching qualification form over the Internet because the financial coordinator can process and send the qualification form within its internal and private computer network.

2) Gaining Access to Multiple Financial Service Providers with Financial Coordinator Acting as a Single Point of Contact

The financial coordinator who runs or manages the computer matching engine may also be an authorized agent to transact business and to close offers on behalf of its wholesale investors. The financial coordinator may also create and maintain computer databases and filters for its wholesale investors. In addition to receiving filters from wholesale investors, the financial coordinator who runs a computer matching engine may also receive and use filters received from other financial service providers. Other financial service providers can include, but are not limited to, a lender, a securities broker, an insurance underwriter, and an insurance agency. Other lenders besides wholesale investors can include, but are not limited to, a warehouse lender, a correspondent lender, a retail financial institution, a retail bank, a retail lender, and a credit card company.

Prior to sending a qualification form to a financial service provider who has a filter that matches the qualification form as discovered through the computer filtering process, the computer matching engine may determine if there are a certain number of filters from wholesale investors (and not any other type of financial service provider) that match the particular qualification form. If the computer matching engine determines that there are a certain number of filters from wholesale investors that match a particular qualification form, then the qualification form may be sent only to these wholesale investors and not to any other financial service providers.

In this way, the financial coordinator may serve as a single point of contact for the consumer in relation to the wholesale investors that have filters which match the qualification form of the consumer. While the financial coordinator may limit access to or disclosure of the number of wholesale investors that match a consumer's particular qualification form, the financial coordinator could disclose all of the wholesale investors that match the consumer's qualification form.

If the computer matching engine determines that there are not a certain number of filters from wholesale investors that match a particular qualification form, then the qualification form may be sent to a group that includes a combination of the wholesale investors and other financial service providers.

As a non-limiting example, a financial coordinator could specify that at least four filters from wholesale investors that match a particular qualification form must be met to prevent a particular qualification form from being sent to other financial service providers beyond the wholesale investors. If there are not four filters from the wholesale investors that match a particular qualification form, the qualification form can be sent to other financial service providers beyond the wholesale investors. Alternatively, if the requisite number of four is not met, the qualification form could be sent to a group that includes only financial service providers and not any of the wholesale investors.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 shows an overview of an exemplary method of the invention;

FIG. 2 shows a schematic depiction of network designed to achieve an exemplary method of the invention;

FIG. 3a shows the steps involving the second stage of an exemplary coordinating process;

FIG. 3b shows the steps involving the third stage of an exemplary coordinating process;

FIG. 4 shows the steps of the fourth stage of an exemplary coordinating process;

FIG. 5 shows the steps of the fifth stage of an exemplary coordinating process;

FIG. 6 shows a schematic of an exemplary filter process, matching an individual financial service provider or wholesale investor to an individual consumer;

FIG. 7A shows various types of exemplary business organizations that may subscribe to computer matching engine services provided by a financial coordinator;

FIG. 7B shows the types of exemplary business organizations that may provide/underwrite financial services or financial products (or both) of financial service providers;

FIG. 7C shows exemplary types of financial products that may be offered by financial service providers and wholesale investors through the coordinating process according to one exemplary embodiment of the present invention;

FIG. 7D shows an exemplary coordinating process where financial service providers and wholesale investors can select from a plurality of consumers;

FIG. 8A shows the steps of the sixth stage of an exemplary coordinating process;

FIG. 8B shows the steps of an exemplary subroutine of FIG. 8A that may be part of the sixth stage of an exemplary coordinating process;

FIG. 9a shows a schematic of the seventh stage of an exemplary coordinating process;

FIG. 9b shows the various transfer methods in the eighth stage of an exemplary coordinating process; and

FIG. 10 shows the steps of the Active File Transfer System in the eighth stage of an exemplary coordinating process;

FIG. 11 shows the steps of the Active File Transfer System in the ninth stage of an exemplary coordinating process; and

FIG. 12 shows the tenth stage of an exemplary coordinating process.

### DETAILED DESCRIPTION OF EXEMPLARY EMBODIMENTS

Overview of Coordinating Information among Financial Service Providers and Consumers

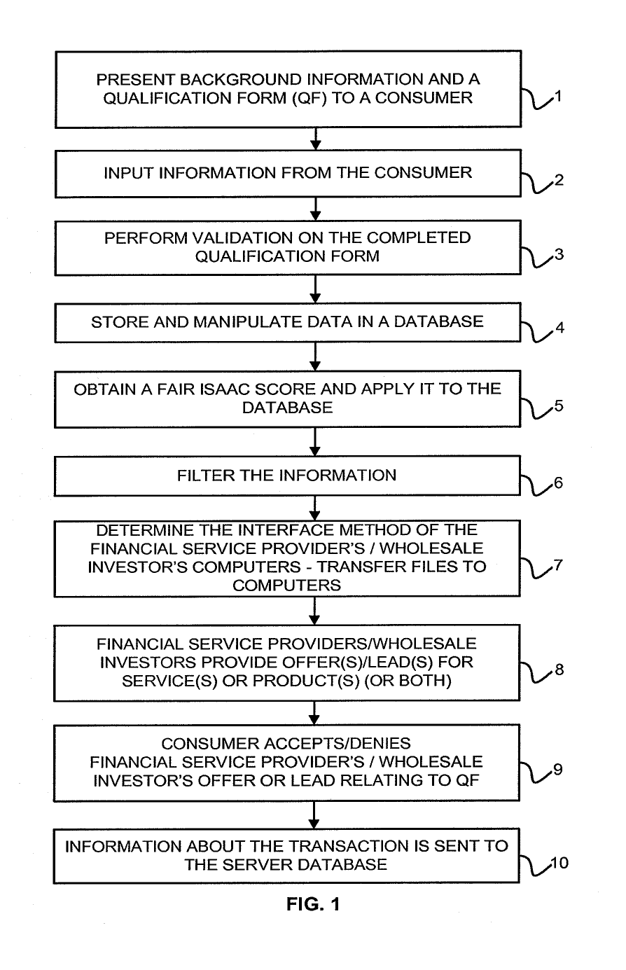

Generally, the invention according to a first aspect is a process and a computer for coordinating qualification forms between financial service providers and consumers via the Internet. FIG. 1 illustrates the ten general stages in the process required to coordinate an electronic qualification form (QF) 115 between a prospective consumer and a plurality of financial service providers.

For example, in stage 1, a qualification form (QF) 115 can be presented to a consumer. This QF 115 can be presented to a consumer over the Internet. Alternatively, the QF 115 can be presented over the phone to the consumer. The QF 115 can also be presented to the consumer by a representative of the financial coordinator during a personal interview. Further, the QF 115 can be presented by numerous other methods, such as, but not limited to, fax, and wireless devices such as PDAs and text messaging using cell phones. The invention is not limited to how data from the QF 115 is presented to a consumer.

In stage 2, the consumer can complete the QF 115 over the internet. Alternatively, the representative of the financial coordinator can complete the QF 115 based on responses from the consumer received over the telephone. Further, the representative can complete the QF 115 during a personal interview with the consumer. Similar to how the QF 115 can be presented to a consumer, the QF 115 can be completed or submitted by numerous other methods, such as, but not limited to, fax, and wireless devices such as PDAs and text messaging using cell phones. The invention is not limited to how data from the QF 115 is entered into a computer matching engine. The invention can include any type of communication channel for entering data from a QF 115 into a computer matching engine.

In stage 3, validation checks are performed on this information to make sure that the QF 115 is complete and correct or certain portions of the QF 115 are complete and correct. Next, stage 4 involves storing and manipulating the QF 115 in a database.

In optional stage 5, a Fair Isaac Credit Score can be obtained based upon the QF 115 and that score is matched to the QF 115 and stored in the database. Next, in stage 6, the QF 115 or data from the QF 115 is filtered where it is compared to a list of criteria presented by a series of financial service providers of the financial coordinator. In stage 6, the financial coordinator can determine if any wholesale investors have filters that match a particular QF 115. If some wholesale investors do have filters that match a particular QF 115, the financial coordinator could only send the QF 115 to these wholesale investors in stage 7 and not to any other financial service provider. In this way, the financial service provider could serve as a single point of contact to a consumer for multiple wholesale investors as will be described in further detail below. If the QF 115 does not match a certain number of filters of wholesale investors, then in stage 7 the QF 115 can be sent to financial service providers other than the wholesale investors or to a group that includes both the wholesale investors and other financial service providers.

In stage 8, financial service providers can process the QF 115 and can either provide an offer or a lead to an offer for a financial product/service based on the QF 115. Alternatively, the financial service providers with filters that match a QF 115 of a particular consumer may elect to not make any offers of financial products/services based on the QF 115 at the time the QF 115 is received.

If a financial service provider offers a financial product or financial service or a lead that may mature into an offer for a financial product or service, then in stage 9, the consumer can reply stating whether he or she accepts or denies the financial service provider's offer or lead based on the QF 115. Finally, in stage 10, information about this transaction is sent to a database to allow financial service providers to have access to the consumer's background.

### Architecture and Detailed Processes

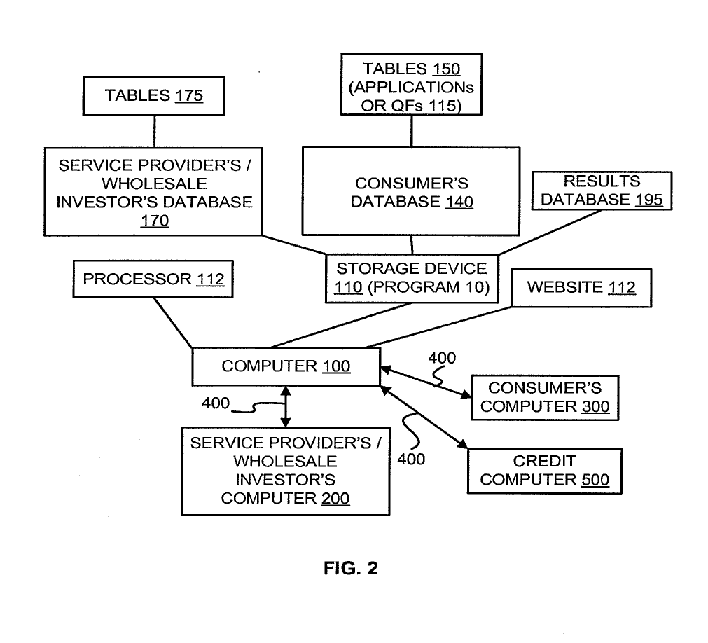

For this process to occur, there can be a series of computers connected to each other via telecommunication lines as shown in FIG. 2. Here, computer program 10, controls the process and is housed on financial services/products processing computer 100. Financial services/products processing computer 100 can coordinate a QF 115 between a series or collection of financial service provider computers 200, and a plurality of consumer computers 300.

Computer program 10 is stored on financial services/products processing computer 100 in a storage device 110 and can be run by processor 112. Program 10 is designed to transmit and receive information through the Internet via a web browser such as Netscape or Internet Explorer, installed on the consumer's computers 300 and financial institution/wholesale investor computers 170. Alternatively, program 10 can receive information directly from a representative of the financial coordinator completing the qualification form data for a consumer.

Financial services/products processing computer 100 usually must have sufficient memory and processor power to project program 10 over the Internet. Therefore, the recommended minimum requirements for processor 12 on computer 100 is an Intel Pentium 200 Mhz processor. The remaining standard components are 64 megabytes of ram, 2 gigabytes of disk space, an Internet connection, additional Ethernet connection, and Windows NT workstation operating system. Computer 100 can be installed with one Ethernet interface directly on the Internet, and the other Ethernet interface connected to a firewall storage device 110, to allow disposition of files on a designated server inside the corporate network. In addition computer 100 could be a Unix style server that interfaces with other Unix and non-Unix based computers on the Internet. Other sizes and number of hardware and software components are not beyond the scope of the invention.

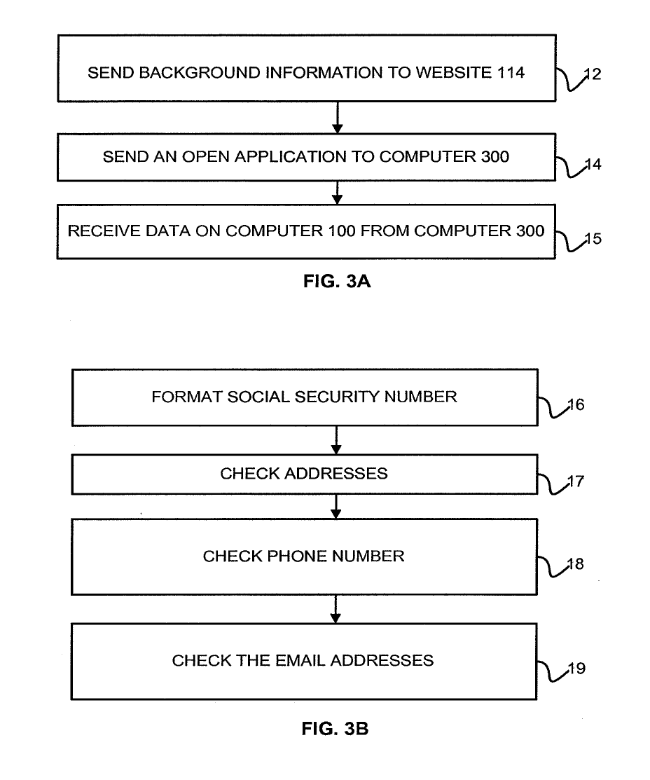

When program 10 runs on computer 100 it instructs computer 100 to interact with other computers through the Internet to co-ordinate a QF 115. For example, as shown in FIGS. 1 and 2, in stage 1, computer 100 allows financial institution/wholesale investor computers 200 to access information on web-page 114 housed in financial services/products processing computer 100 at a predetermined URL address via telecommunication lines 400. In stage 2, computer 100 can allow prospective consumers using satellite computers 300 to view a plurality of documents provided by computer 100. Stage 2 can include a series of steps that are shown in FIG. 3a.

### Stage 2: Processing QFs 115 Over a Computer Network

For example, in step 12 of FIG. 3A, computer 100 can send a QF 115 to a web-site 114. The QF 115 can include background information such as a document welcoming the Internet user to the web site, a document explaining the QF 115 process, and a document explaining the services provided. In step 14, computer 100 can send an open QF 115 to a prospective consumer through the Internet to computer 300. In step 15, the prospective consumer can input information into the QF 115. Alternatively, a representative of the financial coordinator can input information into the QF 115 received from the consumer over the telephone or in person. The QF 115 can be completed over the Internet or over the phone with a representative of the financial coordinator completing the form for the consumer. Alternatively, the QF 115 can be completed during a personal interview by a representative of the financial coordinator when the consumer is being interviewed by the representative. Further, the data for the QF 115 can be submitted by numerous other methods, such as, but not limited to, fax, and wireless devices such as PDAs and text messaging using cell phones. The invention is not limited to how data from the QF 115 is entered into a computer matching engine.

Back to the exemplary Internet example, when the prospective consumer or service representative wants to send this information back to computer 100, he can click a “SEND” button in a graphical user interface of an Internet browser which initiates the third stage of the program 10. As noted above, information sent back to computer 100 can include an entire QF 115 or some data from the QF 115. The computer 100 can start the matching process with some or all of the data from the QF 115. The data from a QF 115 can be any type of data. Such data can include, but is not limited to, name, address, social security number, phone number, e-mail address, occupation, income, debt, amount of loan, requested credit limit, desired financial service or product, etc.

### Stage 3: Validation Checks

FIG. 3B outlines stage 3 wherein computer 100 can send a series of instructions to computer 300 to initiate edit and validation checks. In step 16, computer 100 can check a Social Security number entered by a prospective consumer. In step 17, computer 100 can check the addresses, in step 18 it can check phone numbers, and in step 19 it can check the email addresses entered. The edit and validation checks in stage 3 insure that the data to be received by the database 140 in computer 100 is in the proper format for further processing. If computer 100 determines that the data is in the proper format, then the consumer can then transmit a completed QF 115 to a database on computer 100.

### Stage 4: Encryption

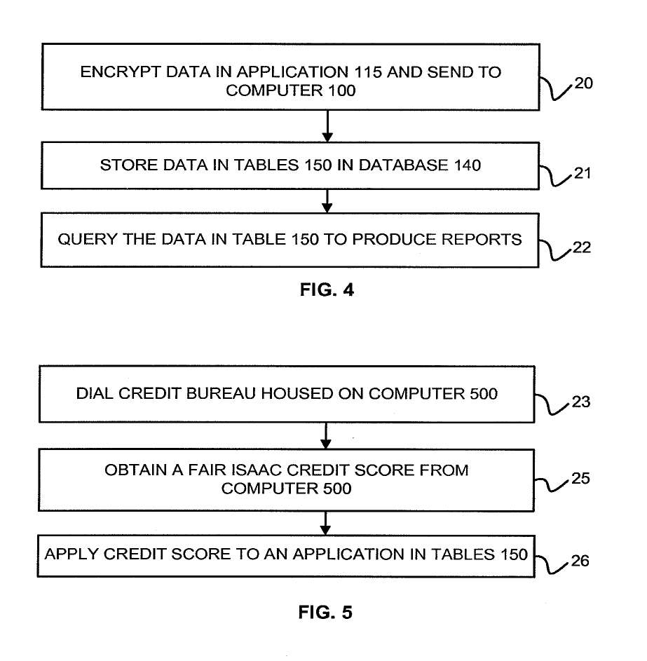

FIG. 4 shows stage 4, wherein in step 20, the data from the completed QF 115 can be encrypted using secure socket layer (SSL) technology. Next in step 21, at the consumers instruction, this information can be sent to computer 100, unlocked and stored in storage device 110 for further manipulation. In this stage, the data from completed QF 115 can be sorted and stored in tables 150 in database 140 based on the type of financial product requested (i.e. mortgages such as business or residential; equity lines of credit; vehicle loans such as for airplanes, automobiles, boats, cars, motorcycles, or any other type of motorized vehicles; educational loans such as for elementary, high school, undergraduate, or graduate education; credit cards, stocks, and bonds). Next, in step 22, program 10 queries the data from tables 150 to produce reports providing loan information based on data given in any field of the QF 115 (i.e., state of residence, consumer income, etc.).

### Stage 5: Credit Bureau Checks

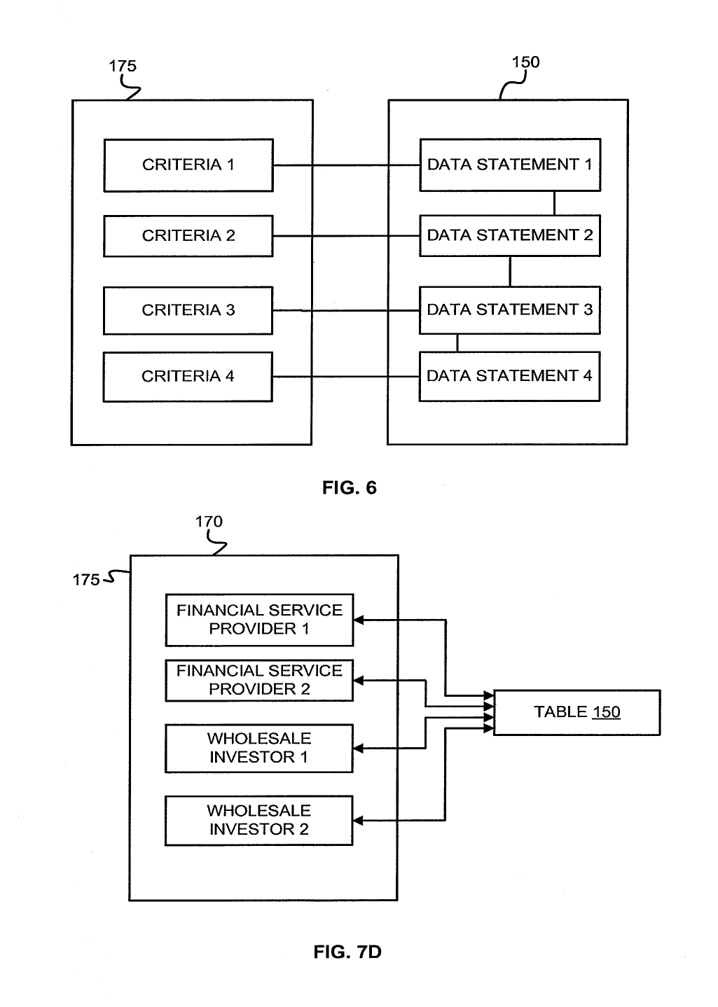

In FIG. 5, computer 100 moves into stage 5, wherein in step 23, computer 100 can dial a credit bureau housed on Credit Computer 500 via telecommunication lines 400. In step 25, computer 100, depending upon the financial product indicated in the QF 115 can obtain a Fair Isaac Credit Score from computer 500 based upon the data sent to computer 500. In some instances, step 25 can be skipped entirely if it is not warranted for a particular financial product or service that is selected by a consumer. Next, in step 26, computer 100 can input the Fair Isaac Credit Score into the database tables 150 if the Credit Score was obtained. Financial service providers can use this Fair Isaac Credit Score as one parameter to calculate a consumer's credit risk. But as noted above, the Fair Isaac Credit Score may not be used as desired, especially for a particular financial product.

### Stage 6: Filtering Process

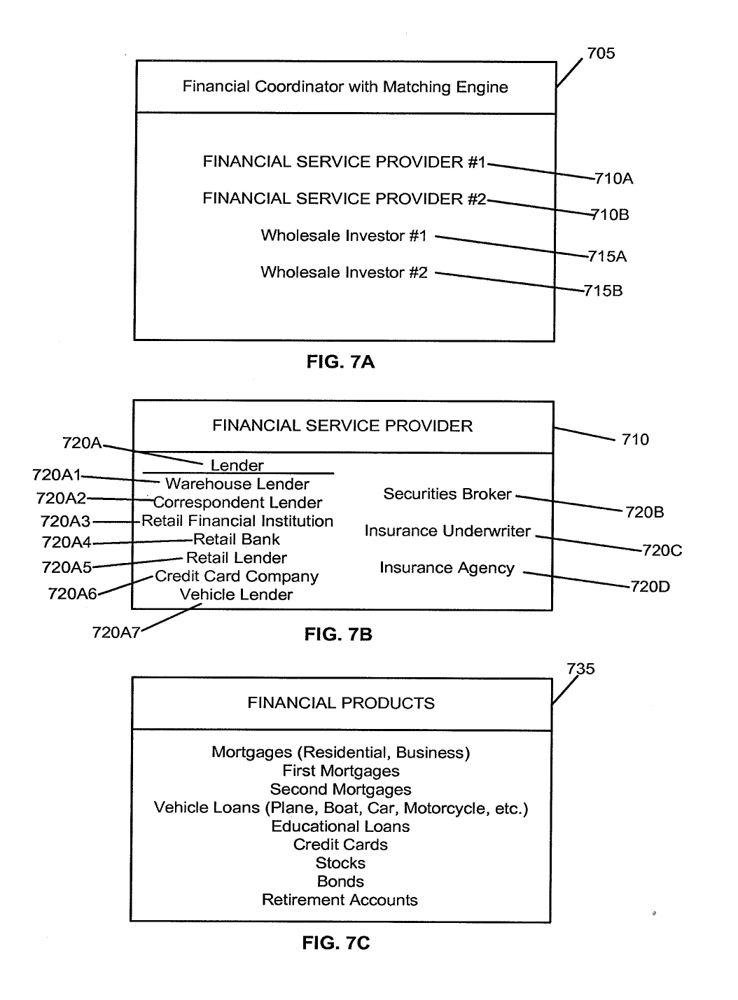

FIGS. 6, 7, and 8 show stage 6 of the process, wherein computer 100 can run a filter to match a completed QF 115 in table 150 against preset criteria established by each financial institution and wholesale investor. As shown in FIG. 6, preset criteria can be stored in tables 175 in a third party financial institution/wholesale investor database 170 on computer 100.

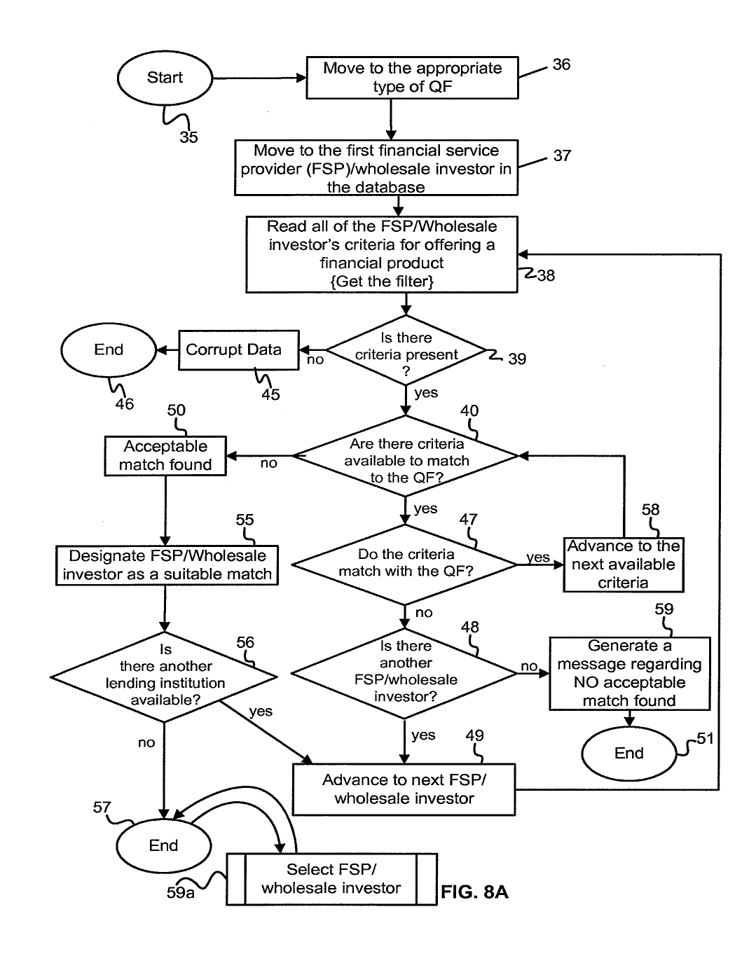

In FIG. 7A, various types of business organizations 710, 715 that may subscribe to computer matching engine services provided by a financial coordinator 705 are illustrated. The financial coordinator 705 manages the computer matching engine services powered by computer 100. Various business organizations 710, 715 may subscribe to the computer matching engine services powered by computer 100. One business organization may include a first financial service provider 710A. Another business organization may include a second financial service provider 710B as well as first and second wholesale investors 715A and 715B of the financial coordinator 705.

The wholesale investors 715A, 715B may allow financial coordinators 705 to offer their products as agents or authorized representatives of the investors 715. As noted in the summary section, a wholesale investor 715 of a financial coordinator 705 may include a business organization that sells specific financial products and that does not directly sell these products to consumers. One example of a wholesale investor 715 is a company who only provides one financial product such as mortgages. Another example of a wholesale investor 715 is a company who only finances automobiles. Other types of wholesale investors 715 are not beyond the scope of the present invention.

Referring now briefly to FIG. 7B, this figure illustrates various types of financial service providers 710 other than wholesale investors 715. Financial service providers 710, other than wholesale investors 715, may include a lender 720A, a securities broker 720B, an insurance underwriter 720C, and an insurance agency 720D. A lender 720A other than a wholesale investor 715 can include, but is not limited to, a warehouse lender 720A1, a correspondent lender 720A2, a retail financial institution 720A3, a retail bank 720A4, a retail lender 720A5, a credit card company 720A6, and a vehicle (e.g. automobile) lender 720A7.

Referring now to FIG. 7C, this Figure illustrates various types of financial products or services (or both) 735 that may be offered through the coordinating process according to one exemplary embodiment of the present invention. As described in the summary section, financial products or services (or both) 735 that are coordinated by the computer 100 may include, but are not limited to, mortgages such as for businesses or home residences; equity lines of credit; vehicle loans such as for airplanes, automobiles, boats, cars, motorcycles, or any other type of motorized vehicles; educational loans such as for elementary, high school, undergraduate, or graduate education; credit cards, stocks, and bonds. However, other types of financial products are not beyond the scope and spirit of the present invention.

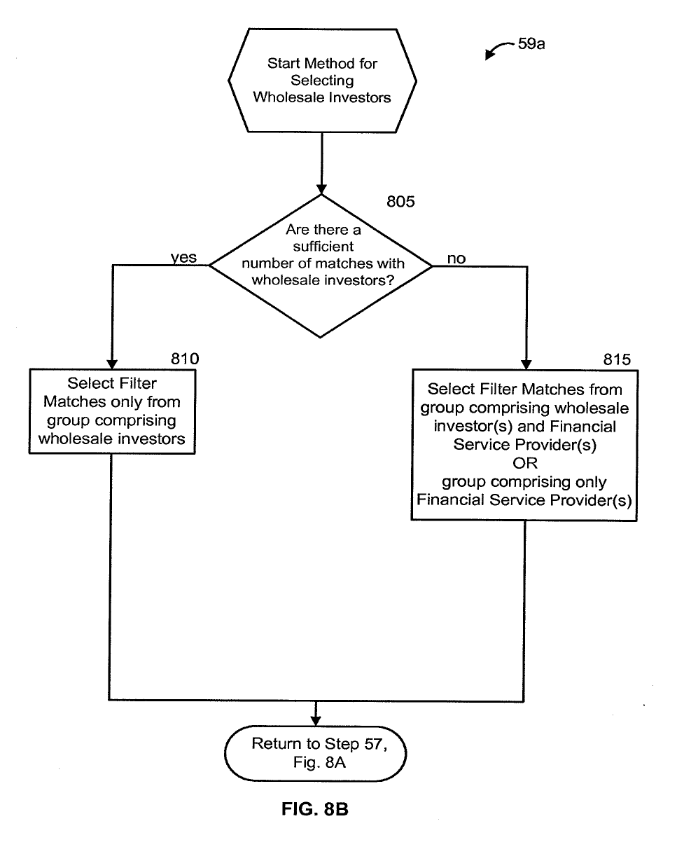

Referring now to FIG. 7D, financial institution/wholesale investor database 170 can include a listing of tables 175 for several different financial service providers 710 and wholesale investors 715. The process for matching consumer's QF 115 in tables 150 to financial service provider criteria in tables 175 is illustrated in FIG. 8A.

### Detailed Filtering Process

Referring now to FIG. 8A, in step 35, program 10 can start a filtering process. Next, in step 36, the filter process initiates and moves to the appropriate type QF 115 in tables 150. Next, in step 37, the filter moves to a first financial service provider 710 or wholesale investor 715 of a financial coordinator 705 in table 175. In step 38, program 10 instructs computer 100 to read all of the financial service provider's or wholesale investor's criteria for extending an offer or a lead to an offer for a financial product or service (or both).

In step 39, program 10 reads whether there are any criteria present in tables 175. If the requested data is not present, next, in step 45 the filter checks to see if there is any database connection that is broken and whether there is any database information in the message. If the criteria are present, step 40 instructs computer 100 to see whether any remaining criteria to match to QF 115 is stored in tables 150.

If there are more criteria to match to QF 115, then in step 47, program 10 checks to see whether that remaining criteria matches with QF 115. If the criteria matches with QF 115 then in step 58, program 10 advances to the next available criteria in tables 175. As shown in FIG. 6, step 58 creates a loop back to step 40. If the criteria does not match with QF 115, then in step 48, program 10 checks to see whether there is another financial service provider 710 or wholesale investor 715 of a financial coordinator 705 in database 170. If there are no remaining financial service provider 710 or wholesale investors 715 in database 170 then in step 59, computer 100 generates a message that no acceptable match has been found. After generating this message, in step 51, the filter process ends.

If there is another financial service provider 710 or wholesale investor 715, then the filter process advances to the next financial service provider 710 or wholesale investor in step 49. Step 49 creates a loop back to step 38 wherein the filter process reads all of the criteria for the new financial service provider 710 or wholesale investor 715 of a financial coordinator 705. This loop continues until in step 40, the filter finds there are no criteria available to match to completed QF 115.

If there are no more criteria to match to QF 115, then in step 50, the filter determines whether there has been an acceptable match between a consumer and a financial service provider 710 or wholesale investor 715 of a financial coordinator 705. If there is an acceptable match, then in step 55, the filter designates that financial service provider 710 or wholesale investor 715 as a suitable organization for QF 115.

In step 56, program 10 checks to see if there is another financial service provider 710 or wholesale investor 715 available, and if the answer is yes, then program 10 advances to the next financial service provider 710 or wholesale investor 715 of a financial coordinator in step 49. If there are no more financial service providers 710 or wholesale investors 715 available, then program 10 advances to step 57 wherein the filter process ends.

Next, in routine 59a, the computer 100 can select a number of matched financial service providers 710 or wholesale investors 715 or both in which to send QF 115. For example, if the filter process matches QF 115 with twenty financial service providers 710 and wholesale investors 715, computer 100 may send QF 115 to only a fraction of those twenty matched financial service providers 710 and wholesale investors 715. That is, the financial coordinator 705 may advertise to its potential consumers 300 that computer 100 may provide up to four offers or four leads that may mature into offers for any one financial product 735 or service that is coordinated by computer 100. The financial coordinator may send the QF 115 to as many financial service providers 710 and wholesale investors 715 as needed to reach the threshold number of four offers or four leads that may mature into offers.

This means that to obtain at least four offers or four leads that may mature into offers when the number is set at four, the financial coordinator may need to send the QF 115 to more than four matched financial service providers 710 and wholesale investors 715. But the financial coordinator can send the QF 115 to less than the total number of matched organizations which in this case was twenty organizations to reach the number of at least four offers or leads that may mature into offers for a consumer.

The process of selecting the financial service providers 710 and wholesale investors 715 that are part of the matched set (in this case, twenty) of routine 59a can based upon either random selection or a predetermined set of criteria stored in computer 100. Alternatively, the QF 115 can be sent to every matched financial service provider 710 and wholesale investor 715. If each financial service provider 710 and wholesale investor 715 provides an offer or a lead to an offer, the financial coordinator 705 can pass all of the offers or leads to the consumer or a fraction of the offers or leads to the consumer.

Routine 59a may further comprise algorithms or logic that enables a financial coordinator 705 to send QFs 115 only to its wholesale investors 715. FIG. 8B illustrates one exemplary process for selecting only wholesale investors 715.

Detailed Filtering Process for Selecting Only Wholesale Investors 715 so that Financial Coordinator Serves as a Single Point of Contact for Consumer

Referring now to FIG. 8B, this Figure illustrates exemplary steps of routine 59a in which a financial coordinator may send business to only its wholesale investors 715 rather than other financial service providers 710. A financial coordinator 705 may want to send business or QFs 115 to only its wholesale investors 715 because the financial coordinator 705 can become a single point of contact for its consumers relative to the wholesale investors 715.

Decision step 805 is the first step of routine 59a. In this decision step 805, the program 10 can determine if there are a sufficient or threshold number of matches with wholesale investors 715 of the financial coordinator 705 for the current QF 115 being evaluated. A threshold number of matches needed for a consumer between filters and a particular QF 115 can be adjusted by the financial coordinator 705. Decision step 805 allows the financial coordinator 705 to send business to its wholesale investors 715 without sending business to other financial service providers 715.

If the program 10 determines that the threshold number of matches for a particular QF 115 have been met by only the financial coordinator's wholesale investors 715, then the “Yes” branch is followed to Step 810. In step 810, the QF 115 is sent only to these wholesale investors 715 who matched with the QF 115 and not to any other financial service providers 710. Similar to what was described above, the financial coordinator 705 may send the QF 115 to as many of its wholesale investors 715 in this step as needed to reach the threshold number of offers (or leads that may mature into offers), and as described above, our example had four offers or leads as the exemplary threshold.

This means that to obtain at least four offers/leads when the threshold offer/lead setting is set at four, the financial coordinator may need to send the QF 115 to more than four matched wholesale investors 715 in Step 810. But the financial coordinator can send the QF 115 to less than the total number of matched organizations which in this case was twenty organizations to reach the threshold setting of at least four offers/leads for a consumer. The process of selecting the wholesale investors 715 in Step 810 that are part of the matched set (in this case, twenty) can based upon either random selection or a predetermined set of criteria stored in computer 100.

If the program 10 determines that there are not enough wholesale investors 715 to reach the threshold offer setting (such as four in our example described above), then the “No” branch is followed to Step 815 in which a particular QF 115 may be sent to a group that includes a combination of other financial service providers 710 and the wholesale investors 715. Alternatively, the QF 115 may be sent to a group that includes only financial service providers 710 other than the wholesale investors 715.

Program 10 cycles through or repeats the process illustrated in FIG. 8A usually several times until the threshold setting or minimum required of matching offers/leads is achieved. This cycling or repetition of steps is needed because financial service providers 710 and wholesale investors 715 can change their filters in “real-time” or instantaneously. This means that filters adjusted by financial service providers 710 and wholesale investors 715 can be updated within minutes or even seconds of previous filter updates.

### Stage 7: Interface Method Determination

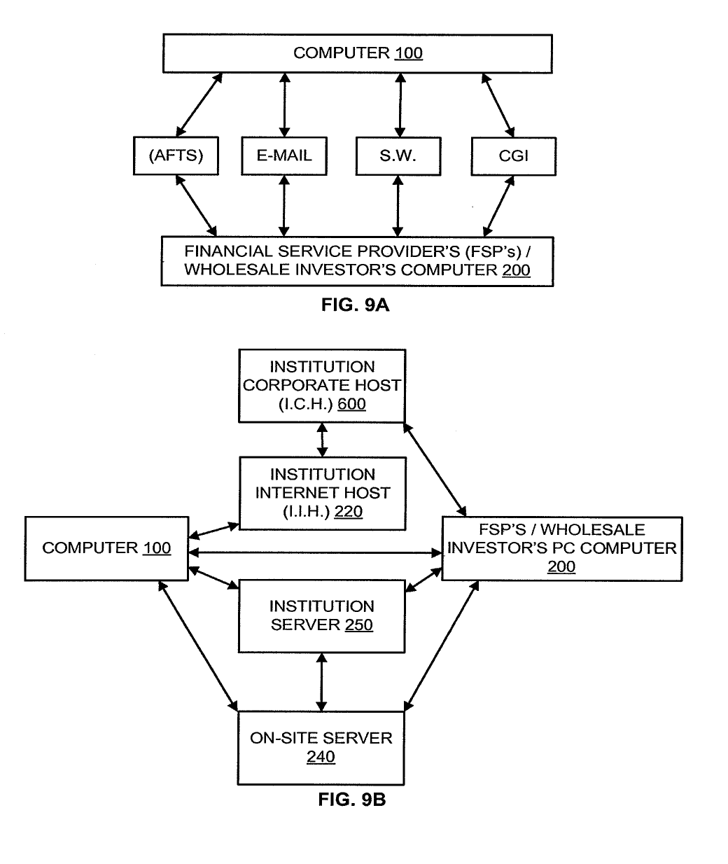

Next, as shown in FIG. 9a in stage 7, program 10 determines the interface method between program 10 and the selected financial institution/wholesale investor computers 200. The remaining Figures may only illustrate a financial service provider 710, but those skilled in the art will appreciate that each financial service provider 710 illustrated could substituted with a wholesale investor 715 of a financial coordinator 705. And therefore, anywhere in the remaining figures in which the term “financial service provider” 710 is used, a wholesale investor 715 of a financial coordinator 705 could be substituted without changing the scope and spirit of the present invention. For those wholesale investors 715 in which a financial coordinator 705 may create and maintain the wholesale investor's filters and databases, the financial coordinator 705 may transmit qualification forms (QFs) 115 within its own, private computer network without using the Internet.

The interface method of FIG. 9a can be Common Gateway Interface (COI), Active File Transfer (AFTS), as a secured file on a secured webpage (S.W.) or via e-mail. Stage 7 allows loan computer 100 to access many different financial service provider sites which thereby allows for greater communication flexibility within the system.

Stage 8: Sending Data via selected Transfer Method

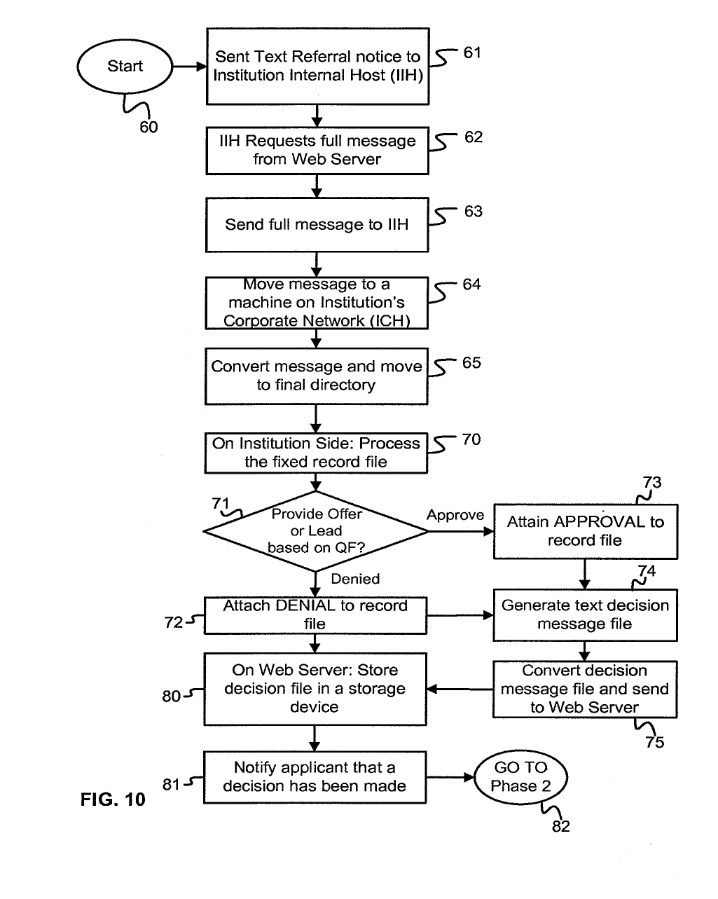

In stage 8, as shown in FIGS. 9a, 9b and 10, computer 100 sends data from table 150 via the interface method selected in stage 7 to the financial service provider 710/wholesale investors 715 selected in the filter process of stage 6. FIG. 10 shows the Active File Transfer System (AFTS) of FIG. 9b in greater detail. For example, in step 60, program 10 instructs computer 100 to start the AFTS. Next, in step 61a text referral notice is sent to the Institution Internet Host (IIH) computer 220. In step 62, IIH computer 220 requests a full message from computer 100. In step 63 computer 100 sends an encrypted full message to IIH computer 220. Next, in step 64 computer 200 moves the message to the Institution's Corporate Network (ICH) 600. In step 65, ICH 600 converts the message from HTML format to a customized fixed record format defined and controlled by the destination institution.

Next, in step 70, outside program 10, this information can be processed and stored in the financial institution's system. In step 71, a financial service provider 710 or wholesale investor 715 of a financial coordinator 705 approves or denies QF 115. If the financial service provider 710 or wholesale investor 715 approves QF 115, it attaches an offer to the record file in step 73. Alternatively if the financial institution does not like the QF 115, then in step 72 it may choose to not send any offers or send a message that it will not provide any offers for this particular QF 115 at this time. In step 74, the financial service provider computers 700 generate a text decision message file. This message file is converted from the existing format into HTML format and sent to computer 100 web-site via encrypted transmission in step 75. The text decision message file contains a financial services/products id number and a request for more information from the consumer. Computer 100 next stores the decision file in database 180 in step 80. Next, in step 81, computer 100 notifies an applicant that a decision has been made.

In addition, the data from QF 115 can also be sent via e-mail with Pretty Good Privacy (PGP) encryption as shown in FIG. 9b. PGP is an encryption program that can be used to encrypt, a binary file to someone, with very high security, without having to exchange a set of private encryption keys beforehand. In this style transfer system, the text of table 150 comprising QF 115, is transformed into an e-mail text message. Next, the e-mail message is encrypted in PGP format. Finally, computer 100 sends the e-mail message to computer 230 which is a remote networked computer on a financial service provider's website.

The third transfer process, that of the secured dynamic website serves as a place for financial service providers 710 or wholesale investors 715 to log in to a website to change their lending criteria filters and to view QFs 115. In this process, information is stored on computer 100 in a website that can be accessed by a financial service provider 710 or wholesale investor 715. To access this site, a financial service provider 710 or wholesale investor 715 of a financial coordinator 705 is given a login access account to log into the website that is encrypted by SSL technology. Once the financial service provider 710 or wholesale investor 715 of a financial coordinator 705 logs into the website, he can download information relating to a consumer's request for information.

In the fourth transfer method, the Common Gateway Interface (CGI) format is shown in FIG. 9b. There, computer 100 sends data from table 150 to institution server 250 via a Common Gateway Interface (CGI) program. CGI programs allow for a server to server interface over which encrypted information can be transferred. For example, the data located on table 150 is first encrypted. Next the data can be sent from computer 100 to institution server 250. Server 250 next stores and unlocks the encrypted data. This unlocked data can then be read by all other networked computers 230 in a financial service provider's/wholesale investor's home network.

### Stage 9: Second Phase of AFTS

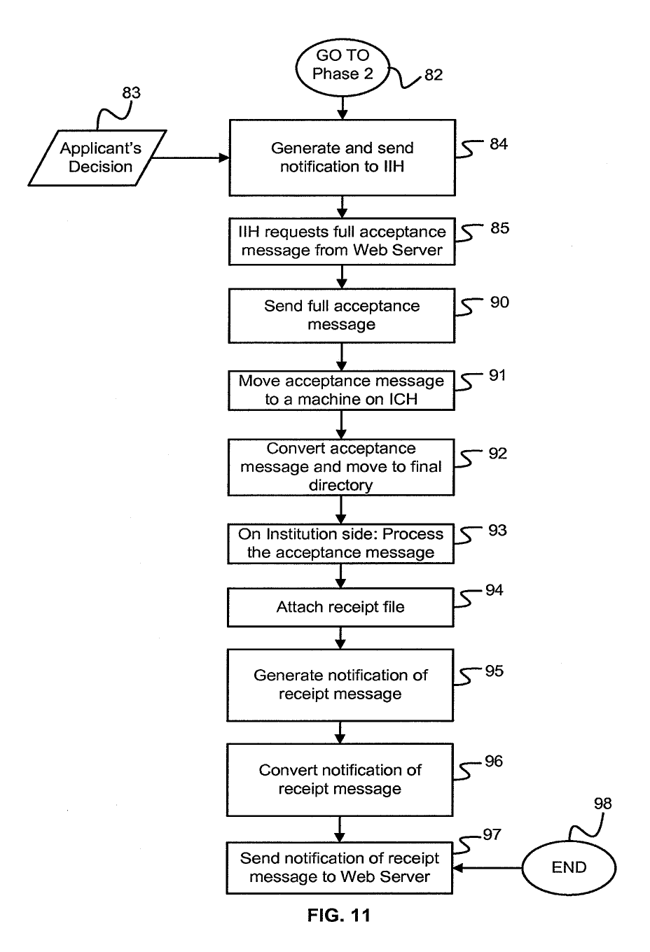

In stage 9, as shown in FIG. 11, computer program 10 moves into the second phase of (AFTS) in step 82. In this stage, the consumer informs the financial service provider 710 or wholesale investor 715 of a financial coordinator 705 of his decision concerning the offers for financial services/products. For example, in step 83 a consumer sends his decision notification from computer 300 to computer 100. Next, in step 84, computer 100 generates and sends a notification to computer 220 (IM). In step, 85 computer 100 sends a full acceptance message to IIH computer 220 and next moves the acceptance message to ICH computer 600 in step 90. After that, in step 91 ICH computer 600 converts the acceptance message from HTML format and moves it to a final directory 190 on computer 230 (step 91).

At this point, a financial service provider program may take over so that in step 93, institution computer 230 processes the acceptance message. In step 94, institution computer 230 attaches a receipt file to the acceptance message. In step 95, institution computer 230 generates a notification of receipt message, and in step 96, it converts the notification from its standard database format into HTML format. Finally, in step 97, ICH computer 600 sends a notification of the receipt message to computer 100 and in step 98 the Active File Transfer System ends.

Stage 10: Contacting a Consumer to Close Offer or to Close Lead that Matures into Offer

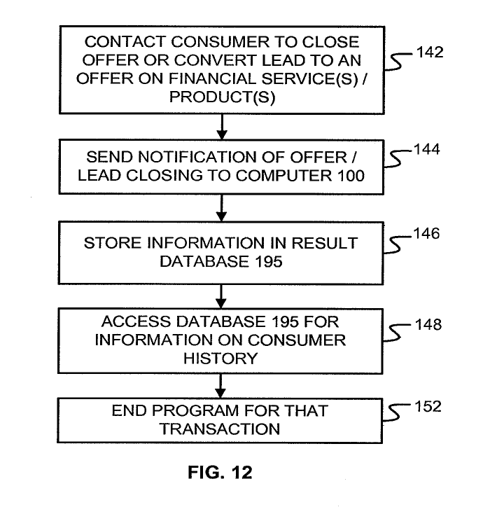

In the tenth and final stage, as shown in FIG. 12, in step 142, the financial service provider 710 or wholesale investor 715 of a financial coordinator 705 contacts the consumer to coordinate the closing of the offer or lead to an offer for financial services/products. Here, the financial service provider 710 or wholesale investor 715 of a financial coordinator 705 has the consumer's name, social security number, id number for the QF 115, phone number at both work and home, and the best time to contact the consumer from the acceptance email sent when the offer or lead to an offer was accepted. The closing on the financial services/products 735 can take place in any way that the financial service provider 710 or investor 715 typically closes.

Once all documents are signed and delivered from the consumer, the transaction may be deemed as closed. Once the financial institution closes a financial service/product, in step 144, it contacts computer 100 and sends a notification of the financial service/product closure. In step 146 computer 100 stores this information in result database 195 which can be accessed by the financial service providers 710/wholesale investors 715 in step 148. Finally in step 152, the process according to the invention ends for that individual transaction.

While several embodiments of the present invention have been shown and described, it is to be understood that many changes and modifications may be made thereunto without departing from the spirit and scope of the invention as defined in the appended claims.

What is claimed is:

1. A computer-implemented method for coordinating a qualification form between a consumer and financial service providers comprising the steps of:
receiving selection criteria from at least one of the financial service providers and a wholesale investor;
receiving data from a qualification form;
employing the selection criteria to filter the data and to automatically select one of a wholesale investor and a financial service provider; and
transmitting the qualification form data to a group comprising wholesale investors if a certain threshold of matches between the qualification form and number of wholesale investors is met.

2. The method of claim 1, further comprising the step of determining an appropriate transfer method to forward the qualification form data to at least one of the selected financial service provider and wholesale investor.

3. The method of claim 1, further comprising the step of displaying a plurality of positive credit decisions from one of the selected financial service provider and wholesale investor.

4. The method of claim 4, further comprising the step of assigning at least one of the financial service provider and wholesale investor a corresponding filter.

5. The method of claim 1, further comprising transmitting the qualification form data to a group comprising wholesale investors and financial service providers.

6. The method of claim 1 wherein each wholesale investor comprises a business organization that sells one of financial services and products not directly to consumers.

7. A computer-implemented method for coordinating business between a consumer and at least one financial service provider and at least one wholesale investor, comprising the steps of:
receiving selection criteria from at least one of the financial service provider and wholesale investor, receiving data sent from the consumer, employing the selection criteria to filter the data;
automatically selecting at least one of the financial service provider and the wholesale investor based on the filtered data; and
transmitting the data to at least one of the financial service provider and wholesale investor, whereby a selected financial service provider and a selected wholesale investor compete with each other for business with the consumer.

8. The method of claim 7, further comprising transmitting one or more leads to the consumer from at least one of a selected financial service provider and wholesale investor.

9. The method of claim 7, further comprising transmitting one or more business offers to the consumer.

10. The method of claim 7, wherein the step of receiving data from the consumer further comprises receiving data from one of a phone, fax, and computer.

11. The method of claim 7, wherein the step of receiving data from the consumer further comprises receiving data from one of a wireless device and a personal hand-held computer.

12. The method of claim 7, wherein each wholesale investor comprises a business organization that sells financial products comprising real estate secured products.

13. The method of claim 7, wherein at least one wholesale investor is affiliated with a financial coordinator that manages a computer matching engine that uses the selection criteria.

14. The method of claim 7, further comprising generating selection criteria for at least one wholesale investor with a financial coordinator, the financial coordinator comprising an authorized agent to transact business and to close offers on behalf of a respective wholesale investor.

15. The method of claim 1, wherein each financial service provider comprises at least one of a lender, a securities broker, an insurance underwriter, and an insurance agency.

16. The method of claim 15, wherein each lender comprises a warehouse lender, a correspondent lender, a retail financial institution, a retail bank, a retail lender, and a credit card company.

17. A computer-implemented method for providing leads to a consumer from at least one of a financial service provider and a wholesale investor comprising the steps of:
receiving data from the consumer;
filtering the data based on electronic tables that are modifiable by each financial service provider and each wholesale investor;
tracking one or more parts of the data that match one or more entries of a respective electronic table; and
in response to a match between the data and one or more entries of a electronic table, sending a lead for a financial service product to the consumer from at least one of a financial service provider and a wholesale investor.

18. The method of claim 17, wherein the lead comprises a least one of a name and a phone number associated with one of the financial service provider and wholesale investor.

19. The method of claim 17, wherein each wholesale investor comprises a business organization that sells financial products comprising real estate secured products.

20. The method of claim 17, wherein the financial product relates to at least one of a business loan, an asset secured by real estate, a commercial mortgage, a first mortgage, a second mortgage, insurance, a car loan, a student loan, a personal loan, a credit card, a bank account, a stock brokerage account, a retirement account, an equity line of credit, a vehicle loan, stock, and bond.
